(19) United States
(12) Patent Application Publication
(10) Pub. No.: US 2010/0027267 A1
(43) Pub. Date: Feb. 4, 2010

(54) REFRACTOR AND LIGHTING APPARATUS

(76) Inventor: Gerard Francis Hamilton, Dublin (IE)

Correspondence Address: HOFFMANN & BARON, LLP, 6900 JERICHO TURNPIKE, SYOSSET, NY, 11791, US

(21) Appl. No.: 12/447,088

(22) PCT Filed: Oct. 30, 2007
(86) PCT No.: PCT/IE2007/000105

§ 371 Date: Jul. 21, 2009

(30) Foreign Application Priority Data
Oct. 27, 2006 (IE) S2006/0794

(51) Int. Cl. F21V 17/02; F21V 5/02; F21S 6/00; F21V 7/00; F21V 29/00

(52) U.S. Cl. 362/282; 362/339; 362/311.07; 362/296.01; 362/294

(57) ABSTRACT

A lighting apparatus (1,2) comprising optical elements (3), electrical elements and an attachment device (4). The optical elements (3) comprise a refractor (10) attachable to the attachment device (4). The refractor (10) comprises two planar members (101, 102) and an arcuate member (103) connecting the planar members (101, 102) to define a cavity (104). Each member having an inner and an outer surface. The optical elements (3) further comprising a light source (11) mountable within the cavity (104) of the refractor by means of a lampholder (11a) positioned in the attachment device (4). The refractor (10) further comprises a plurality of prismatic surfaces (101a, 102a, 103a) wherein at least one prismatic surface is the inner surface (101a, 102a) of at least one planar member and at least one prismatic surface is the outer surface (103a) of the arcuate member.

The present invention relates to a refractor and an electrical lighting apparatus with a refractor and in particular to an electrical lighting apparatus suitable for commercial and industrial environments.

It is common knowledge that refraction occurs when light waves travel from a medium with a given refractive index to a medium with a different refractive index. At the boundary between the media, the wave's phase velocity is altered. This causes the light striking the boundary between two media at an angle to be refracted and enter the new medium at a different angle (Huyghens principle), or to be reflected away from it. The amount of reflected light and the degree of bending of the light's path will depend on the angle that the incident beam of light makes with the surface, and on the ratio between the refractive indices of the two media (Snell's law). In optics, a prism is a transparent optical element with flat, polished surfaces that refracts light. Light distribution in a luminaire apparatus is often controlled using refractors, which utilise both Huyghens Principle and Snell's law to redirect light waves. Typically this is achieved using a refractor unit that contains prismatic optics.

Irish patent S83099 discloses a luminaire apparatus comprising a housing containing optical and electrical elements. The optical element included a reflector unit that has a generally concave shape along its longitudinal axis with a bulb mounted centrally along the longitudinal axis in the interior of the reflector unit. The interior surface of the reflector unit has a plurality of reflective facets that greatly increase the reflective capacity of the apparatus over known prior art such as conventional high bay and fluorescent lighting installations. As a consequence, the disclosed luminaire apparatus has significantly improved illumination of warehouses and large warehouse type stores where the lighting apparatus is mounted at heights of 6 m and higher. In order to achieve optimum energy savings and the most effective illumination using the disclosed luminaire apparatus, it has been found that the luminaire apparatus needs to be mounted at heights between 6 m and 14 m.

Traditionally in domestic premises or conventional retail environments ceilings are lower than 6 m. Surface mounted or recessed lighting apparatus are normally used on these lower ceilings to illuminate the area beneath the ceiling. The lighting apparatus disclosed in S83099 is not efficient in these environments as it illuminates in a downward plane only thus the area above the actual light fitting is dark. This in turn creates a tunnel effect in the area between the upper surface of the apparatus, the ceiling and the nearest adjacent lighting apparatus. This type of light is not suitable for domestic or conventional retail environments as it is not aesthetically pleasing especially in retail environments.

An object of the present invention is to seek to alleviate the problems associated with low mounted luminaire apparatus.

The present invention provides a refractor comprising two planar members and an arcuate member connecting the planar members, each member having an inner and an outer surface characterised in that the refractor further comprises a plurality of prismatic surfaces wherein at least one prismatic surface is the inner surface of at least one planar member and at least one prismatic surface is the outer surface of the arcuate member.

The present invention also provides a lighting apparatus comprising optical elements, electrical elements and an attachment device, the optical elements comprising a refractor attachable to the attachment device, the refractor comprising two planar members and an arcuate member connecting the planar members defining a cavity, each member having an inner and an outer surface, the optical elements further comprising a light source mountable within the cavity of the refractor by means of a lampholder positioned in the attachment device characterised in that the refractor further comprises a plurality of prismatic surfaces wherein at least one prismatic surface is the inner surface of at least one planar member and at least one prismatic surface is the outer surface of the arcuate member.

The advantage of the refractor lies in the position of the prismatic surfaces. The prismatic surfaces manipulate the angles and direction through which light waves travel, such that light is both refracted and reflected thereby eliminating the tunnel effect associated with known prior art.

Conveniently the inner and outer surfaces of each planar member and arcuate member are contiguous thus forming a continuous inner surface and a continuous outer surface respectively.

Advantageously the refractor is formed from highly refractive material, for example, in a preferred embodiment of the invention the refractor is made from machined UV stabilised acrylic material. Ideally there is very little or no diffusion from the material used to form the refractor. Conveniently in the preferred embodiment of the invention the refractor is formed by either injection moulding or extrusion or a combination of both techniques.

Prismatic optics are formed as desired on the surface of the refractor during manufacture. Ideally to achieve the required distribution effect prismatic optics the acrylic material is formed in a vacuum. Persons skilled in the art know other materials from which it would be deemed suitable to form the refractor and indeed other techniques by which the prismatic optics can be formed. The prismatic optics of the refractor are carefully designed to ensure that light is refracted and reflected within the refractor to eliminate the tunnel effect associated with known prior art.

Conveniently in the preferred embodiment the refractor comprises an elongate structure having a generally cross-sectional parabolic shape along its longitudinal axis. It is of course understood that the refractor could have any one of the following cross-sectional shapes; c-shape or hyperbolic shape or elliptical shape.

In the preferred embodiment the light source is positioned centrally along the longitudinal axis within the cavity of the refractor. Conveniently beams of light emitted from the light source radiate towards the inner surface of the refractor and downwards through the opening at the mouth of the parabola.

Ideally some of the light waves emitted by the light source will strike the prisms on the inner surface of the planar member, when this occurs light is refracted through the refractor and reflected towards the inner surface of the arcuate member. Conveniently when light strikes the inner surface of the arcuate member, light is refracted though the refractor until it strikes the prismatic surfaces on the outer surface of the refractor. In this way most light is distributed downwards through the opening at the mouth of the parabola and a small amount of light is refracted through the refractor and is used to illuminate the area around the lighting apparatus thereby eliminating the tunnel effect.

Optionally the optical elements of the lighting apparatus further comprise a rotatable reflector mountable centrally along the said longitudinal axis in the interior of the refractor by means of a fixing device wherein the reflector is positioned between the refractor and the light source. The fixing device enables the reflector to rotate about the longitudinal axis of the lighting apparatus. It is also possible to place a further fixing device at the opposite end of the reflector remote the attachment device. Ideally the fixing device comprises a cam system within a cradle harness. It is of course understood that the invention is not limited to this type of fixing device, which is given by way of example only. Any suitable fixing device that enables the reflector unit to rotate about the longitudinal axis of the lighting apparatus known to the person skilled in the art can be used.

Ideally the position of the rotatable internal reflector unit can be altered to achieve one or more of the following light distribution effects; down-lighting, wherein the illuminating light from the apparatus is focussed away from the ceiling towards the ground; up-lighting wherein the illuminating light from the apparatus is focussed towards the ceiling away from the ground; asymmetric lighting wherein the light is directed at an angle. Alternatively a combination of down-lighting, up-lighting or asymmetric lighting at various levels can be used. Advantageously it is possible to programme movement of the reflector unit, hence programme the direction of light emitted.

Advantageously the lighting apparatus comprises one or more optical elements.

In a first embodiment the lighting apparatus comprises two pairs of optical elements, each optical element in a pair positioned at opposing sides of the attachment device forming an overall cruciform shaped structure.

In a second embodiment the lighting apparatus comprises a pair of optical elements positioned at opposing sides of the attachment device forming an elongate linear structure.

Ideally the attachment device further comprises support means. Preferably the refractor is supported by support means when attached to the attachment device. Conveniently the support means and refractor can be held in position in the attachment device by fixing means.

Preferably the attachment device accommodates all necessary electrical and power control infrastructures of the lighting apparatus. Optionally the attachment device has a plurality of air vent openings to prevent overheating of the lighting apparatus.

Conveniently the reflector is formed from a highly reflective material, for example, high polished high purity aluminium. It is of course understood that any suitable reflective material known to the person skilled in the art can be used. Advantageously the reflector can also be used to reflect heat away from the surface of the refractor.

Conveniently the lighting apparatus accommodates multi-wattage and/or multi-light sources.

Preferably in the first embodiment of the lighting apparatus, the light source comprises linear surface mounted and/or recessed luminaire, capable of accommodating a plurality of light sources, for example, a 35 W, 36 W or 54 W light source typically 1200 mm in length or a 49 W, 58 W or 80 W light source typically 1500 mm in length.

Preferably in the second embodiment of the lighting apparatus, the light source comprises a range of compact fluorescent light sources, for example, varying from 36 W, 40 W, 55 W and 80 W.

Advantageously a plurality of different wattage light sources can be contained within one apparatus.

Such a range of light sources offers the user the ability to tailor the lighting design criteria all the while using the same lighting apparatus. It is of course to be understood that the lighting apparatus is not limited to this type of light source, the aforementioned wattages or the aforementioned length of the light source, indeed any suitable light source, wattage or length can be used in the apparatus of the invention.

Preferably the lighting apparatus is designed to provide focussed illumination, in particular when using either a standard 26 mm diameter linear tube known as a T8 or a standard 16 mm diameter linear tube known as a T5 or compact multi-wattage single ended lamps. Ideally the T8 and T5 are used in the first embodiment of the lighting apparatus and the compact multi-wattage single ended lamps are used in the second embodiment lighting apparatus.

Optionally the light source comprises a photometric light source.

Conveniently it is also possible to adjust the illumination levels emitted from the lighting apparatus. Advantageously this can be achieved using a building management system whereby the lighting apparatus can be remotely programmed to achieve different lighting levels.

A further embodiment of the lighting apparatus of the present invention is fitted with an integrated control system, which allows for each apparatus to track the presence of natural light and react accordingly to predetermined light levels. Alternatively this is achieved by programming levels on an integrated sensor, which then track daylight availability. In essence this enables the intensity of the light source within the apparatus to be adjusted and controlled by natural light levels.

Optionally the control system of the lighting apparatus comprises an integrated address system which facilitates programming of the apparatus and enables the apparatus to readily accept a command and reflect the lighting aspiration i.e. mood settings, optical changes, colour changes, etc. Conveniently the apparatus can be programmed using a remote PC at commissioning stage or alternatively while in place to set different lighting programmes for example during a specific retailing and commercial event. Further examples include fashion displays or typical merchandising fares, which are tailored in terms of lighting aesthetics. Optionally a program can be uploaded and addressed to either individual lighting apparatuses or globally to all of the apparatuses in place.

Ideally the lighting apparatus comprises one or more sensors, for example, PS425A sensors, which detect levels of light within the building, and indeed external influences, which would affect the level of illumination, required within the building. Ideally the user is able to program the control system so that when the illuminated area is unoccupied, illumination levels are reduced to a minimum light level. The advantage of this system for the user is that the control system provides background lighting while offering minimal energy consumption e.g. after businesses have shut, retail, commercial or otherwise, it may be preferable to offer background lighting for cleaning of work areas or general highlight of merchandising.

Optionally the lighting apparatus further comprises one or more integrated LEDs. Conveniently the system can track the visible light spectrum and pay particular attention to areas of notable interest for example, shop displays at night or decorative and valued commercial displays during the day. Advantageously when the light levels are reduced the integrated LEDs can be programmed to scroll the visible spectrum from blue to red and offer a pleasing aesthetic lighting, for example, to passers by where buildings have visible frontages. Advantageously LEDs have a lifecycle of between 5 to 10 years. This means that if the LEDs remain on for long periods of time, for example, overnight there will not be any consequences to the effective lifecycle of the lighting apparatus of the present invention.

Ideally in addition to tracking of natural light, the control system also provides means for integrated occupancy dynamic detection.

Conveniently the control system further provides instantaneous responses to changes in occupancy and natural light which in turn provides for efficient use of the apparatus thus energy during periods of non-occupancy by either switching down or switching off the apparatus. Ideally the control system is provided with a default mechanism which enables the lighting apparatus to reduce their power consumption from 100% to 5%, thus maintaining lighting to all apparatus while enhancing lighting quality.

Ideally the lighting apparatus has a light output ratio range of approximately 92% to 98%. Preferably the light output ratio is approximately 96% therefore the energy demands of each apparatus is particularly low. The light output ratio is determined by the efficiency of the lighting apparatus in a controlled laboratory environment. It is of course understood that this level will vary in accordance with different environments.

Preferably the lighting apparatus of the present invention is further provided with a height adjusting device wherein the lighting apparatus can be lowered from its position on the ceiling and subsequently returned to its starting position at ceiling level. This facility enables users to lower that apparatus to easily access the fittings for the purpose of changing the light source, for example, if a bulb has blown and then readily return to its original position. The advantage of this is that it allows relamping whilst reducing costs significantly. It also avoids the necessity for scaffolding or the hiring of access equipment and eliminates any safety issues pertaining to relamping.

Advantageously the lighting apparatus can be raised and lowered by remotely programming the integrated control system.

The invention will hereinafter be more particularly described with reference to the accompanying drawings which illustrate by way of example only, two embodiments of the invention.

In the drawings;

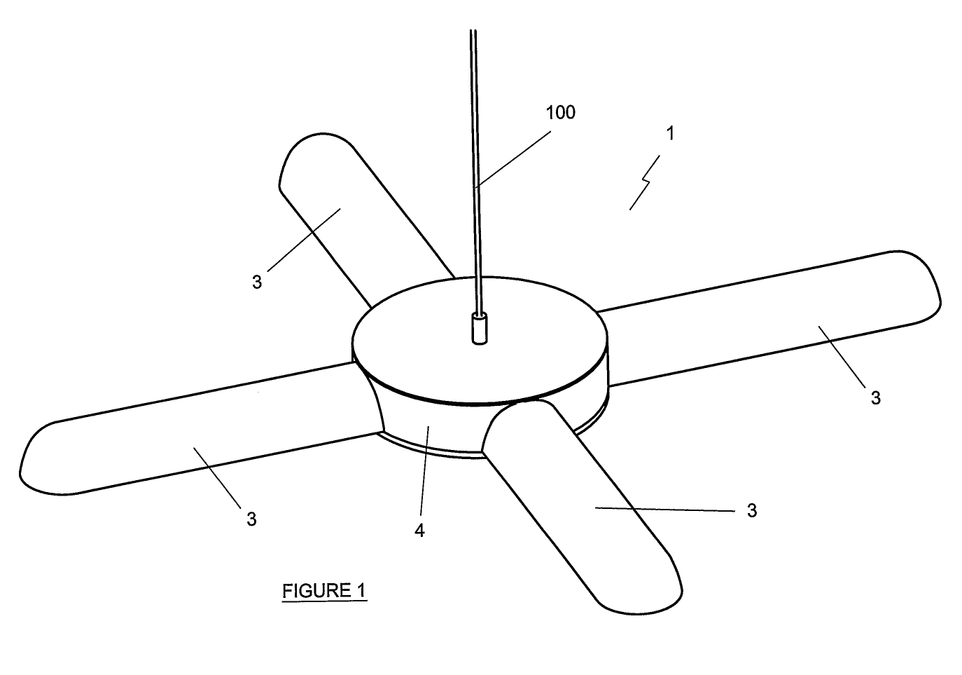

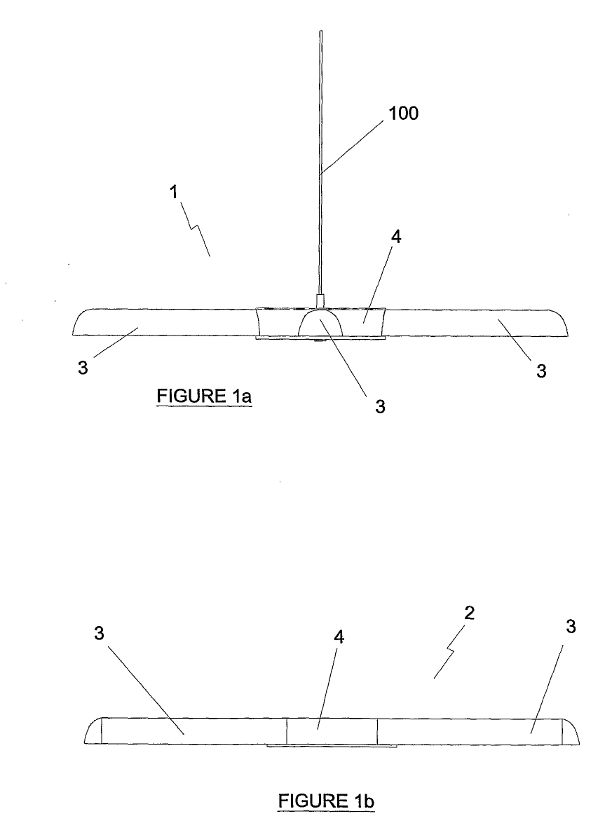

FIG. 1 is a perspective view of the first embodiment of the lighting apparatus of the invention;

FIG. 1a is a side view of the lighting apparatus of FIG. 1;

FIG. 1b is a side view of the second embodiment of the lighting apparatus of the invention;

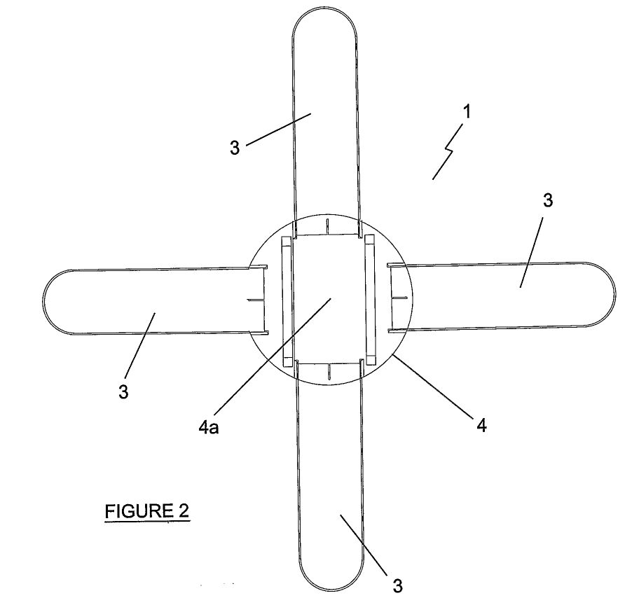

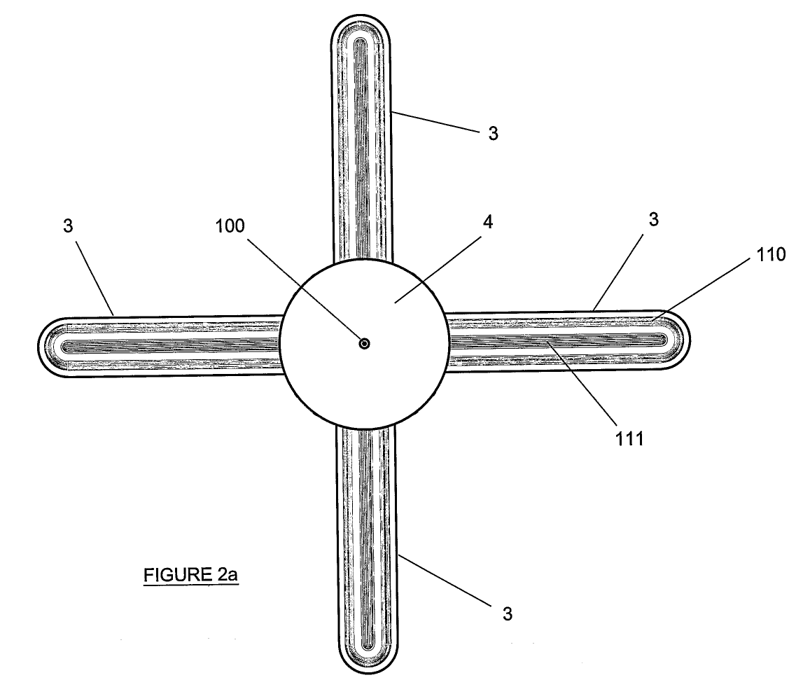

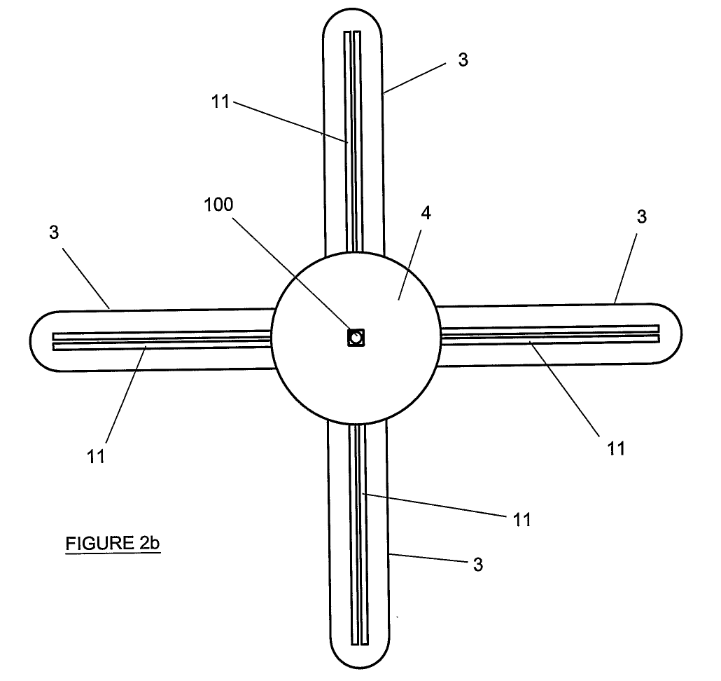

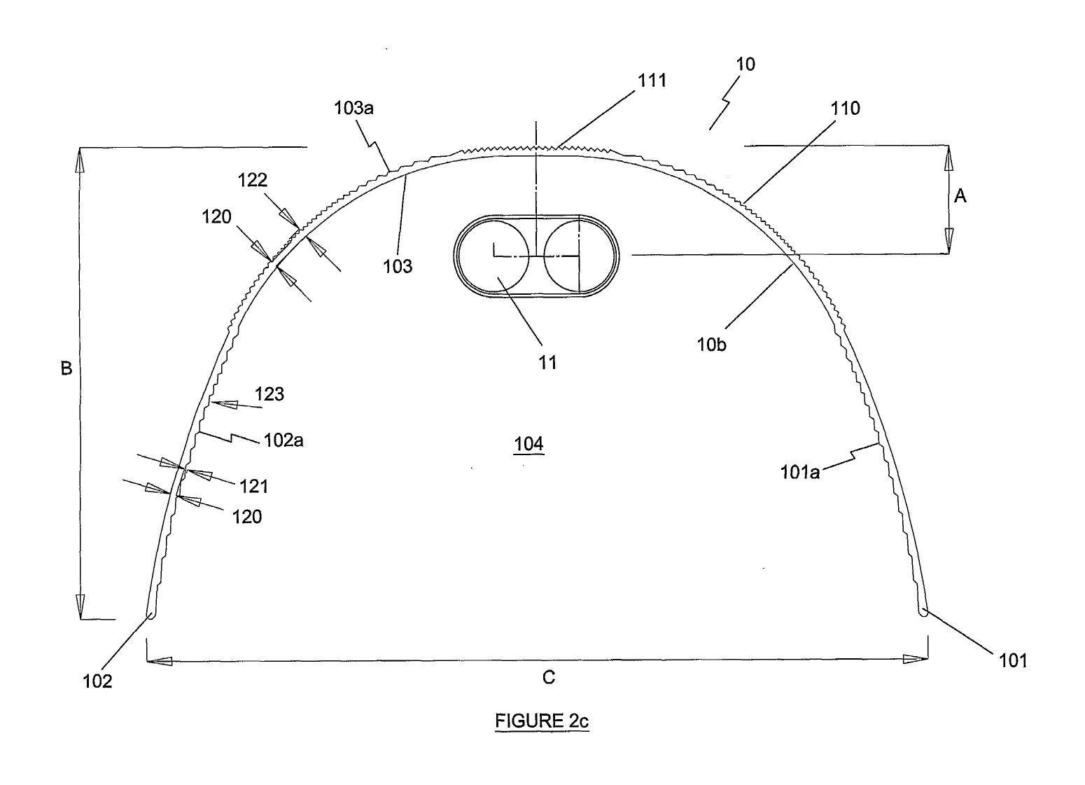

FIG. 2 is a cross-sectional plan view of the first embodiment of the lighting apparatus of FIG. 1;

FIG. 2a is a plan view of the top of the lighting apparatus of FIG. 1;

FIG. 2b is a plan view of the underside of the lighting apparatus of FIG. 1;

FIG. 2c is an enlarged cross-sectional end view of the refractor of the lighting apparatus of the invention;

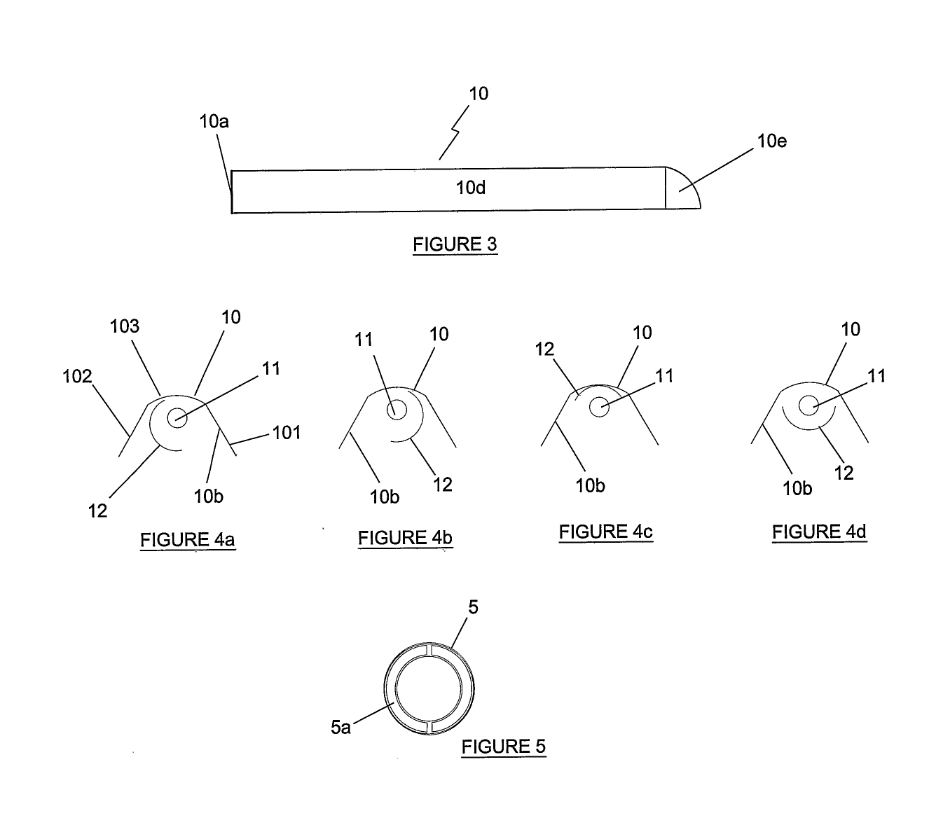

FIG. 3 is a side view of the refractor of the apparatus of the invention;

FIGS. 4a to 4d are cross-sectional end views of the lighting apparatus of the invention showing the reflector in different positions;

FIG. 5 is a side view of the fixing device of the apparatus of the invention;

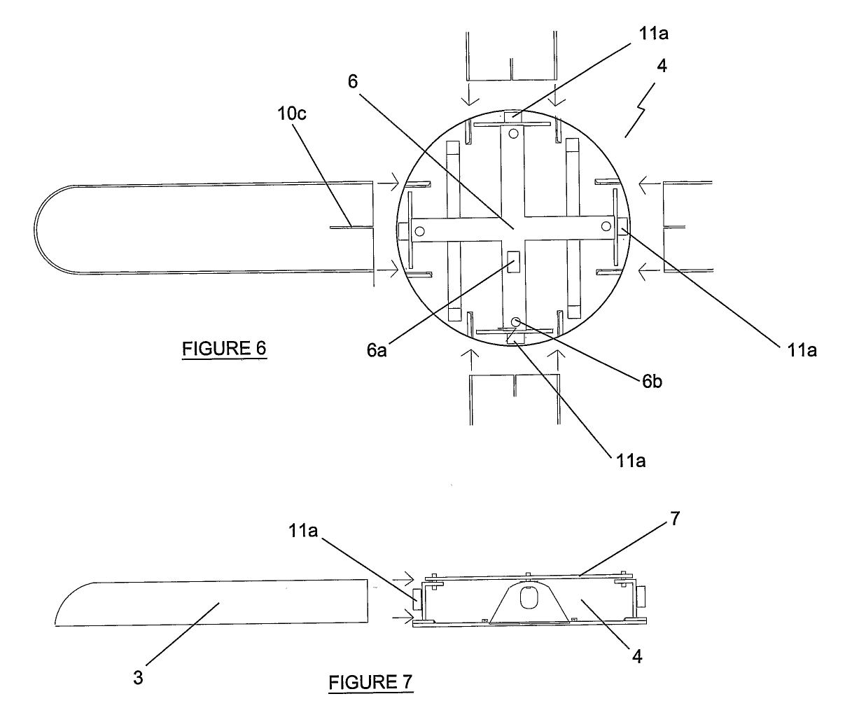

FIG. 6 is a cross-sectional plan view of the metal fixing device of the second embodiment of the invention;

FIG. 7 is a cross-sectional partial side view of the metal fixing device and support means of the lighting apparatus of the invention; and

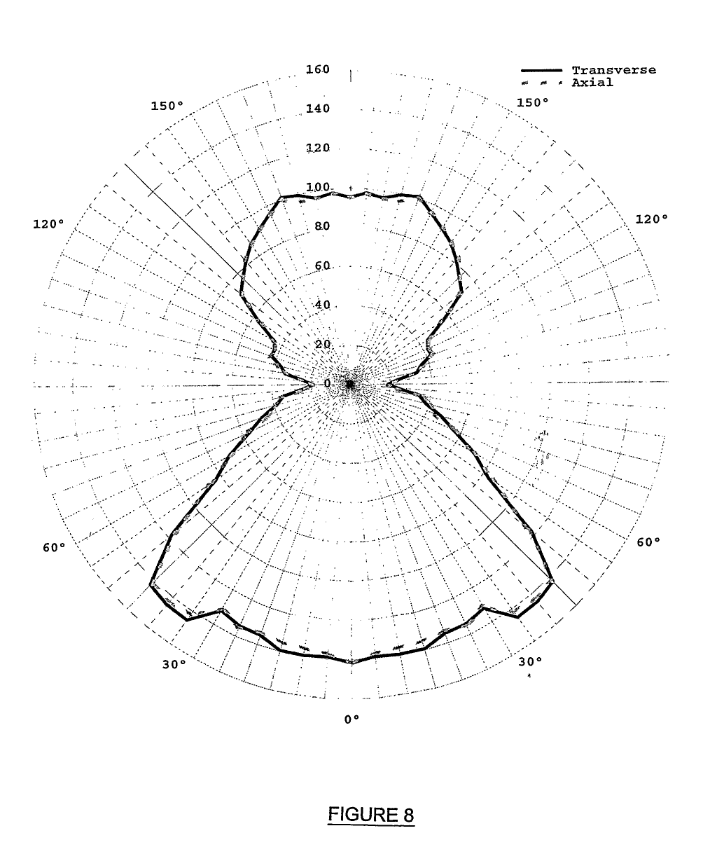

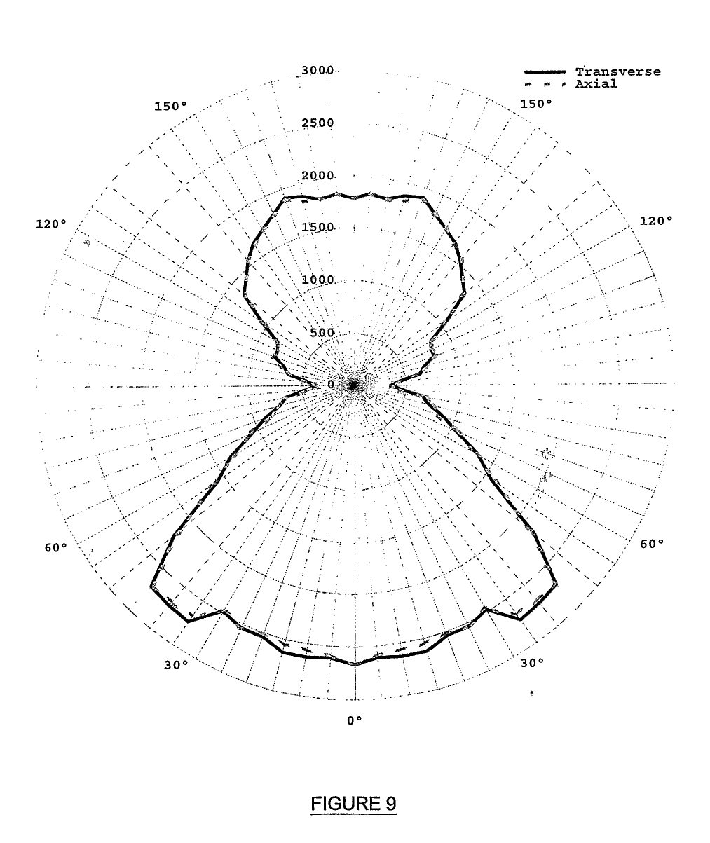

FIGS. 8 and 9 are average principal axes luminous intensities graphs for the first embodiment of the apparatus of the invention.

Referring to the drawings and initially to FIGS. 1 and 1a there is shown a first embodiment of the lighting apparatus 1. In the first embodiment the lighting apparatus 1 comprises four optical elements 3 which are attached to the attachment device 4 forming an overall cruciform shaped structure. The apparatus 1 is suspended from a ceiling using support 100. It is understood that although not shown, electrical means to power the apparatus are supplied to the device through the support means 100.

FIG. 1b is a side view of the second embodiment of the lighting apparatus 2, therein a pair of optical elements 3 are positioned at opposing sides of the attachment device 4 forming an elongate linear structure. It is understood that this lighting apparatus also has support means 100 although not shown.

FIG. 2 is a cross-sectional plan view of the first embodiment of the lighting apparatus of FIG. 1, therein two optical elements 3 are held in position in the attachment device 4 by means of fixture 4a.

Referring now to FIGS. 2a, 2b, 2c and 3, the optical elements 3 comprise a refractor 10, which is an elongate structure attachable at one end 10a to the attachment device 4 and has a curved end 10e remote from end 10a. The refractor comprises two planar members 101, 102 and an arcuate member 103 connecting the planar members 101, 102 defining a cavity 104. A light source 11 is mounted within the cavity 104 by means of a lampholder (not shown) positioned in the attachment device 4.

Each of the planar members 101, 102 and the arcuate member 103 has an inner and an outer surface. The inner and outer surfaces of each member are contiguous thus forming a continuous inner surface 10b and a continuous outer surface 10d respectively. Both inner and outer surfaces 10b and 10d are highly polished refractive surfaces.

The prismatic optics of the refractor are carefully designed to ensure that light is refracted and reflected within the refractor to eliminate the tunnel effect associated with known prior art. The inner surface 10b of refractor 10 has two prismatic surfaces 101a and 102a, which are the inner surfaces of planar members 101, 102. Arcuate member 103 has a prismatic surface 103a on its outer surface.

The cross-sectional dimensions of the refractor and prismatic optics are predetermined to achieve maximum refraction, reflection and illumination in the desired direction. In this embodiment of the invention the refractor 10 has a generally cross-sectional parabolic shape along its longitudinal axis. In FIG. 2c the centre of light source 11 is positioned approximately 26 mm±0.5 mm from the outermost point of the prismatic optics 103a positioned directly above light source 11 shown as distance A. The cross-sectional dimensions of refractor 10 are indicated as height B 113 mm±0.5 mm and distance C 189.5 mm±0.5 mm wherein distance C is defined as the distance between opposing ends of planar members 101, 102 remote from arcuate member 103.

Distance 122 between the inner and outer surface of reflector 10 is 2.25 mm±0.02 mm regardless of whether prismatic optics are positioned on the inner or outer surface. Distance 122 in effect comprises two layers the first layer 120 being defined as the distance from the smooth surface to the start of the prism layer and the second layer 121 being defined as the distance from the start of the prism layer to the end of the prism layer wherein the distance of the first layer 120 is 1.50±0.02 mm and the distance of the second layer is 0.75 mm±0.02 mm. All prism radii 123 are defined as 0.2 mm±0.02 mm. It is of course understood that these measurements are relative to the size of the refractor and position of the light source within the refractor. Alteration of one or more of these parameters could in turn affect each of the other parameters.

As shown in FIG. 2c the prismatic optics comprises a plurality of prisms stacked together on the inner and outer surfaces 101a, 102a and 103a respectively. The angles of the prisms on the prismatic surfaces vary with the angles through which the arcuate and planar members 101,102,103 curve to achieve the generally cross-sectional parabolic shape. On the outer surface 103a of arcuate member 103 directly above light source 11 prisms 111 are stacked closely together and their angles are exact and do not vary. As the prisms 111 extend outwards from this position along the outer surface 103a of the arcuate member 103, the angle of the prism 110 alters. The effect of having the prisms stacked closely together with the same angle is that some light waves are internally reflected and refracted.

Luminaire performance is sometimes described in terms of efficiency and effectiveness with which a luminaire delivers light to an intended target. Photometric testing indicates the light distribution pattern and the intensity by which the light is distributed of a luminaire apparatus. FIGS. 8 and 9 show Average Principle Axes Luminous Intensities in cd/klm and cd, respectively for lighting apparatus 1. The photometric centre of apparatus 1 was taken as the geometric centre of the front face of refractor 10. The photometric nadir (Point 0) was taken to be perpendicular to the front face of refractor 10. Apparatus 1 was treated as though it had two planes of symmetry through the 0°/180° (transverse) plane and the 90°/270° (axial) plane. The average principal axes luminous intensities above and below the photometric nadir in effect correspond to the light distribution pattern and intensity of the light above the lighting apparatus (between the apparatus and the ceiling) and below the lighting apparatus (between the apparatus and the ground). The average principal axes luminous intensities show the light distribution pattern above and below the light fitting. The intensity of the light distribution above the apparatus is approximately 100 cd/klm in contrast with the light distribution intensity below the apparatus, which is approximately 145 cd/klm. A full listing of the luminous intensities recorded are listed in Example One below.

EXAMPLE ONE
AVERAGE LUMINOUS INTENSITIES

| | |
|---|---|
| TRANSVERSE PLANE | AXIAL PLANE |

| Angle/° | cd/Klm | cd | cd/Klm | cd |
|---|---|---|---|---|
| 0 | 141.55 | 2661.13 | 141.55 | 2661.13 |
| 5 | 138.76 | 2608.74 | 136.86 | 2573.04 |
| 10 | 139.53 | 2623.09 | 136.02 | 2557.25 |
| 15 | 139.49 | 2622.41 | 135.43 | 2545.99 |
| 20 | 134.90 | 2536.05 | 133.15 | 2503.14 |
| 25 | 134.84 | 2535.00 | 135.00 | 2538.04 |
| 30 | 131.80 | 2477.92 | 130.54 | 2454.09 |
| 35 | 145.36 | 2732.75 | 142.33 | 2675.82 |
| 40 | 144.91 | 2724.38 | 142.79 | 2684.48 |
| 45 | 143.06 | 2689.61 | 142.08 | 2671.01 |
| 50 | 117.74 | 2213.60 | 116.17 | 2184.06 |
| 55 | 83.84 | 1576.15 | 85.53 | 1608.01 |
| 60 | 71.17 | 1337.94 | 70.33 | 1322.21 |
| 65 | 56.93 | 1070.33 | 56.84 | 1068.59 |
| 70 | 47.18 | 886.92 | 44.88 | 843.66 |
| 75 | 38.50 | 723.75 | 40.46 | 760.64 |
| 80 | 34.58 | 650.03 | 36.05 | 677.83 |
| 85 | 23.62 | 443.98 | 23.04 | 433.17 |
| 90 | 19.15 | 360.05 | 18.61 | 349.96 |
| 95 | 23.51 | 442.06 | 23.52 | 442.12 |
| 100 | 33.85 | 636.35 | 32.73 | 615.33 |
| 105 | 36.25 | 681.59 | 37.16 | 698.52 |
| 110 | 42.68 | 802.40 | 43.67 | 821.02 |
| 115 | 42.30 | 795.31 | 42.05 | 790.49 |
| 120 | 44.22 | 831.25 | 44.35 | 833.81 |
| 125 | 57.15 | 1074.42 | 55.86 | 1050.15 |
| 130 | 72.04 | 1354.40 | 71.52 | 1344.63 |
| 135 | 76.68 | 1441.54 | 76.78 | 1443.39 |
| 140 | 82.19 | 1545.23 | 83.15 | 1563.20 |
| 145 | 87.41 | 1643.28 | 87.21 | 1639.64 |
| 150 | 91.16 | 1713.74 | 91.36 | 1717.56 |
| 155 | 95.60 | 1797.35 | 95.57 | 1796.80 |
| 160 | 101.55 | 1909.22 | 100.21 | 1883.91 |
| 165 | 99.44 | 1869.43 | 96.52 | 1814.62 |
| 170 | 96.09 | 1806.48 | 96.15 | 1807.71 |
| 175 | 97.89 | 1840.27 | 98.00 | 1842.33 |
| 180 | 95.25 | 1790.71 | 95.25 | 1790.71 |

Optionally two tracking lines are provided on the interior surface of the arcuate member 103 to ensure that the profile and rigidity of refractor 10 is retained when refractor 10 is placed in position on the lighting apparatus 1, 2.

Either injection moulding or extrusion or a combination of both techniques forms refractor 10.

Referring now to the remaining Figures, the light source 11 is positioned centrally along the longitudinal axis in the interior of refractor 10 by means of lamp holder 11a (See FIGS. 6 and 7) in attachment device 4. The lighting apparatus 1 comprises either linear surface mounted or recessed luminaire, capable of accommodating a plurality of light sources 11, for example, a 35 W, 36 W or 54 W light source typically 1200 mm in length or a 49 W, 58 W or 58 W light source typically 1500 mm in length. In contrast the second embodiment of the lighting apparatus 2 comprises a range of compact fluorescent light sources 11, for example, varying from 36 W, 40 W, 55 W and 80 W.

Either embodiment of the lighting apparatus 1 or 2 are designed to provide focussed illumination. One method of achieving this is by using either a standard 26 mm diameter linear tube known as a T8 or a standard 16 mm diameter linear tube known as a T5 or a compact multi-wattage single ended lamp. Ideally the compact multi-wattage single ended lamps are used in the first embodiment of the lighting apparatus 1 and the T8 and T5 are used in the second embodiment of the lighting apparatus 2.

The optical element 3 further comprises a rotatable reflector 12 mounted centrally along the longitudinal axis in the interior of the refractor 10 by means of a fixing device 5 (FIG. 5). The reflector 12 is formed from a highly reflective material, for example, high polished high purity aluminium. The fixing device 5 enables the reflector 12 to rotate about the longitudinal axis of the lighting apparatus 1, 2. The fixing device 5 comprises a cam system (not shown) within a cradle harness 5a. The reflector 12 is positioned between the refractor 10 and the light source 12 so that when the reflector 12 rotates it can achieve one or more of the following light distribution effects;
(a) asymmetric lighting (FIGS. 4a and 4b) wherein the light is directed at an angle;
(b) down-lighting (FIG. 4c) wherein the illuminating light from the apparatus is focussed away from the ceiling towards the ground; and
(c) up-lighting (FIG. 4d) wherein the illuminating light from the apparatus is focussed towards the ceiling away from the ground.

Referring now to FIGS. 6 and 7, there is shown a cross sectional plan view of the attachment device 4 for the first embodiment 1 of the lighting apparatus. The attachment device 4 comprises a cruciform shaped central portion 6. It is appreciated that the attachment device for the second embodiment of the lighting apparatus of the invention comprises a linear shaped central portion instead of a cruciform shaped central portion 6. The lampholders 11a are positioned at each end of the central portion 6. A quick release mains plug 6a is also positioned on the central portion 6.

Support means 7 are attached to the central portion 6. The refractor 10 is supported by support means 7 and secured to the attachment device by means of a securing pin 6b which inserts into the central portion 6. Each refractor 10 is fitted with a slot mechanism 10c (FIG. 6) which allows the refractor 10 to be placed into the correct docking position in the central portion 6. Once the refractor 10 has reached the correct position a pim nut (not shown) locates the securing pin 6b. The tracking lines provided on the interior surface 10b of each refractor 10 ensure that the profile of the refractor 10 is retained and also provides rigidity to the refractor 10 once it is tightened into position using the pim nut.

The attachment device 4 accommodates all necessary electrical and power control infrastructures for the lighting apparatus 1, 2. The attachment device 4 has a plurality of air vent openings (not shown) to prevent overheating of the lighting apparatus 1, 2.

It will of course be understood that the invention is not limited to the specific details described herein, which are given by way of example only, and that various modifications and alterations are possible within the scope of the invention.

1-27. (canceled)

28. A refractor comprising two planar members and an arcuate member connecting the planar members wherein the refractor has an elongate structure having a longitudinal axis and an opening which extends along the longitudinal axis, each member having an inner and an outer surface characterised in that the refractor comprises a plurality of prismatic surfaces wherein at least one prismatic surface is the inner surface of at least one planar member and at least one prismatic surface is the outer surface of the arcuate member and the members of the refractor are arranged to distribute light from a light source through the opening in a first direction and refract light in a second direction through the members of the refractor wherein the first direction opposes the second direction.

29. A refractor as claimed in claim 28, wherein the inner and outer surfaces of each planar member and arcuate member are contiguous forming a continuous inner surface and a continuous outer surface respectively.

30. A refractor as claimed in claim 29, wherein the refractor comprises an elongate structure having a generally cross-sectional parabolic shape along its longitudinal axis.

31. A refractor as claimed in claim 29, wherein the refractor comprises an elongate structure having a generally cross-sectional c-shape or hyperbolic shape or elliptical shape along its longitudinal axis.

32. A refractor as claimed in claim 28, wherein the refractor comprises an elongate structure having a generally cross-sectional parabolic shape along its longitudinal axis.

33. A refractor as claimed in claim 28, wherein the refractor comprises an elongate structure having a generally cross-sectional c-shape or hyperbolic shape or elliptical shape along its longitudinal axis.

34. A refractor as claimed in claim 29, wherein the refractor is formed from highly refractive material.

35. A refractor as claimed in claim 29, wherein the refractor is made from UV stabilised acrylic material.

36. A lighting apparatus comprising optical elements, electrical elements and an attachment device, the optical elements comprising a refractor attachable to the attachment device, the refractor comprising two planar members and an arcuate member connecting the planar members defining a cavity, wherein the refractor has an elongate structure having a longitudinal axis and the cavity extends along the longitudinal axis, each member having an inner and an outer surface, the optical elements further comprising a light source mountable within the cavity of the refractor by means of a lampholder positioned in the attachment device characterised in that the refractor further comprises a plurality of prismatic surfaces wherein at least one prismatic surface is the inner surface of at least one planar member and at least one prismatic surface is the outer surface of the arcuate member and the members of the refractor are arranged to distribute light from a light source through the opening in a first direction and refract light in a second direction through the members of the refractor wherein the first direction opposes the second direction.

37. A lighting apparatus as claimed in claim 36, wherein the inner and outer surfaces of each planar member and arcuate member are contiguous forming a continuous inner surface and a continuous outer surface respectively.

38. A lighting apparatus as claimed in claim 37, wherein the refractor comprises an elongate structure having a generally cross-sectional parabolic shape along its longitudinal axis.

39. A lighting apparatus as claimed in claim 36, wherein the lighting apparatus further comprise a rotatable reflector mountable centrally along the said longitudinal axis in the interior of the refractor by means of a fixing device wherein the reflector is positioned between the refractor and the light source.

40. A lighting apparatus as claimed in claim 39, wherein a further fixing device is placed at the opposite end of the reflector remote the attachment device.

41. A lighting apparatus as claimed in claim 39, wherein the fixing device comprises a cam system within a cradle harness.

42. A lighting apparatus as claimed in claim 36, wherein the lighting apparatus comprises one or more optical elements.

43. A lighting apparatus as claimed in claim 42, wherein the lighting apparatus comprises two pairs of optical elements, each optical element in a pair positioned at opposing sides of the attachment device forming an overall cruciform shaped structure.

44. A lighting apparatus as claimed in claim 42, wherein the lighting apparatus comprises a pair of optical elements positioned at opposing sides of the attachment device forming an elongate linear structure.

45. A lighting apparatus as claimed in claim 36, wherein the attachment device further comprises support means.

46. A lighting apparatus as claimed in claim 36, wherein the attachment device further comprises fixing means.

47. A lighting apparatus as claimed in claim 36, wherein the attachment device further comprises a plurality of air vent openings.

48. A lighting apparatus as claimed in claim 36, wherein the light source comprises a photometric light source.

49. A lighting apparatus as claimed in claim 36, wherein the lighting apparatus further comprises an integrated control system.

50. A lighting apparatus as claimed in claim 49, wherein the integrated control system further comprises an integrated address system.

51. A lighting apparatus as claimed in claim 49, wherein the lighting apparatus comprises one or more sensors.

52. A lighting apparatus as claimed in claim 49, wherein the lighting apparatus further comprises one or more integrated LEDs.

53. A lighting apparatus as claimed in claim 49, wherein the control system also provides means for integrated occupancy dynamic detection.

54. A lighting apparatus as claimed in any one of claim 36, wherein the lighting apparatus further comprises a height adjusting device.
